(19) United States
(12) Patent Application Publication
(10) Pub. No.: US 2025/0003125 A1
(43) Pub. Date: Jan. 2, 2025

(54) MULTI-USE CLEANING TOWEL WITH IMPROVED QUAT EFFICACY

(71) Applicant: KCooper Brands, Inc., Aurora, CO (US)

(72) Inventor: Greg Roth, Tinley Park, IL (US)

(21) Appl. No.: 18/344,063

(22) Filed: Jun. 29, 2023

(51) Int. Cl. D04H 3/16; B08B 1/00

(52) U.S. Cl. CPC D04H 3/16; B08B 1/143; D10B 2509/026

(57) ABSTRACT

A cleaning towel is made from a fabric prepared by a melt blown process using a particular type of material. The fabric is designed to have a weight density in a particular range such that the cleaning towel is light in weight. The cleaning towel also transfers at least a particular percentage amount of a liquid cleaning solution to a surface on which the cleaning towel is placed.

### BACKGROUND

At food service outlets, after each seating, a table or other surface, needs to be cleaned. Typically, cleaning towels are made from a cloth material. However, these cleaning towels may not thoroughly clean the surface. For example, the cleaning towel may absorb a cleaning solution. As a result, the cleaning solution may not be adequately provided on the surface.

### SUMMARY

The present application describes a process for making and packaging a cleaning towel. In an example, the cleaning towel is made of a plastic like material and has a weight and/or a density such that the cleaning towel is relatively light though durable enough for disposable use. The cleaning towel may further have a liquid cleaning solution displacement of a relatively high value. Further, the cleaning towel is packaged for dispensing from a rectangular dispenser, a square dispenser or other non-circular dispenser as a dry article. In an example, the cleaning towel is manufactured and packaged as a continuous roll. Each cleaning towel in the roll of cleaning towels may be separated from an adjacent cleaning towel by a plurality of perforations. In an example, the roll of cleaning towels is coreless (e.g., is not wrapped around a center dowel or core). As such, each cleaning towel may be dispensed from a center of the dispenser. Although specific examples are given, the cleaning towels may be formed in, and dispensed from, any number of configurations.

In an example, the cleaning towels are rolled at a specific tension. The cleaning towels may also be rolled to define a coreless center from which the cleaning towels are dispensed. The coreless center has a particular size that enables the roll of cleaning towels to be compressed to fit in a rectangular dispenser. The tension, in combination with the diameter of the coreless center, enables the roll of cleaning towels to be compressed while still enabling the cleaning towels to be center dispensed. In other examples, the cleaning towels may be side dispensed from a roll. In yet another example, the cleaning towels may be folded.

Accordingly, in one example, the present disclosure describes cleaning towel. In an example, the cleaning towel includes a fabric prepared by a melt blown process using a particular type of material. In an example, the fabric designed to have a weight density in a particular range such that the cleaning towel is light in weight. Additionally, the cleaning towel is manufactured to transfer at least a particular percentage of a liquid cleaning solution to a surface on which the cleaning towel is placed.

The present application also describes a product that includes a continuous sheet of a fabric prepared by a melt blown process. In an example, the fabric is designed to have a weight density that is below predetermined threshold value. Additionally, the fabric is designed to have a liquid displacement characteristic that meets a particular criterion. In an example, the continuous sheet is also designed to be separable by a plurality of perforations.

The present application also describes a method that includes placing a melt blown cleaning towel in a cleaning solution. When the cleaning towel has absorbed the cleaning solution, the melt blown cleaning towel is placed on a surface. The surface may then be cleaned with at least an eighty-five percent quat efficacy.

### BRIEF DESCRIPTION OF THE DRAWINGS

Non-limiting and non-exhaustive examples are described with reference to the following Figures.

FIG. 1 is a microscopic view of a cleaning towel according to an example.

FIG. 2A is a top view of a roll of cleaning towels according to an example.

FIG. 2B is a perspective view of the roll of cleaning towels shown and described with respect to FIG. 2A according to an example.

FIG. 3A is a top view of a roll of cleaning towels that have been according to an example.

FIG. 3B is a perspective view of the compressed roll of cleaning towels shown and

described with respect to FIG. 3A according to an example.

FIG. 4 illustrates a roll of cleaning towels being disposed in a rectangular dispenser according to an example.

FIG. 5 illustrates a roll of cleaning towels being disposed in a dispenser according to an example.

FIG. 6 illustrates a method for using a cleaning towel according to an example.

### DETAILED DESCRIPTION

In the following detailed description, references are made to the accompanying drawings that form a part hereof, and in which are shown by way of illustrations, specific examples, or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

At food service outlets, shops, showrooms and/or retailers, a table, a chair, or other surface need to be cleaned. Currently, various cleaning towel options are available including using a cleaning towel made of cloth or a wet disposable paper towel. However, as described herein, the currently available options are not viable or have certain disadvantages. For example, a cleaning towel made from a cloth material may not be able to clean with a desired efficacy. For example, a cloth cleaning towel may absorb a cleaning solution and not subsequently release an equivalent amount of cleaning solution. As such, the cloth cleaning towel may not adequately transfer the cleaning solution to a surface. Further, due to the cloth material used in making such a cleaning towel, a unit price for the cleaning towel may also be high. As such, the cloth cleaning towel is not suitable for a single use type of application. An alternative is to use a wet disposable paper towel. However, the wet disposable paper towel is also inconvenient due to a higher unit price and a higher maintenance care required to use the wet disposable paper towel.

Accordingly, the present disclosure describes a multi-use cleaning towel that is highly effective in cleaning various types of surfaces including, but not limited to, glass, wooden, plastic, ceramic, and so on. In some examples, after a number of uses, the multi-use cleaning towel may be disposed of. The improved cleaning towel according to the various examples described herein may be prepared in various shapes and/or sizes. The cleaning towel may also be available in various packaging forms including, but not limited to, a container or a dispenser made using a paper, a cardboard, a corrugated paper, and/or plastic, and of various shapes and sizes. Since the cleaning towel described herein is not pre-soaked in a liquid cleaning solution, the cleaning towel is made available to an end user (e.g., a restaurant owner) in what is generally known as an “open bucket” application rather than a “closed bucket” application (requiring a cleaning towel to be pre-soaked and kept in a container with a lid).

The cleaning towel may be made from a fabric and/or using a melt blown process. For example, the fabric may be made using a polypropylene (PP) type of material, polyethylene (PE) type of material, Bio-PE type of material, Bio-PP type of material, and/or other similar material. As such, the cleaning towel may therefore be at least partially comprised of a plastic material. Additionally, or alternatively, the fabric material may be a biodegradable plastic material.

In some examples, the material (e.g., the plastic or biodegradable plastic) may be processed through a melt blown process to produce a nonwoven fabric. During the melt blown process, polymers of the fabric material are converted into continuous filaments, which are then used to make a nonwoven fabric of the continuous filaments which are randomly laid. Since the cleaning towel is made of a nonwoven fabric of plastic material, the cleaning towel may absorb a liquid cleaning solution when the cleaning towel is submerged in a bucket of the liquid cleaning solution but may release an equivalent amount of the liquid cleaning solution. For example, when the wet cleaning towel made from the nonwoven fabric of plastic material is placed on another surface for cleaning, the most, all or substantially all of the liquid cleaning solution may be transferred to the other surface being cleaned. For example, an amount of liquid cleaning solution transferred from the cleaning towel to the other surface (which may be referenced herein as a displacement) may be high. In some cases, the displacement (or efficacy) may be between approximately 90%-100%.

In addition to the type of material being used for making the cleaning towel, the cleaning towel may be further improved by making the cleaning towel light in weight. A cleaning towel that is light in weight may reduce a unit cost of the cleaning towel as less material may be required. Further, the cleaning towel that is light in weight may also reduce freight and/or shipping charges per each unit of a cleaning towel.

In some examples, a cleaning towel of a lower weight may be created using a fabric material of a certain weigh density measured as grams per square meter (GSM). While currently available cleaning towels are made of a fabric having a weight density not less than 61 GSM, the cleaning towel described herein may have a weight density less than 60 GSM, and in some cases a weight density of as low as 10 GSM. In one example, the cleaning towel has a weight density of between 20 GSM to 50 GSM. In this example, the cleaning towel is light in weight, strong enough to use for cleaning of various types of surfaces (as described herein) and has a higher than 85% displacement of cleaning solution on a surface.

Accordingly, the present application describes a cleaning towel made from a fabric material and having a particular weight density such that the cleaning towel is light in weight, strong enough to use for cleaning various types of surfaces, has a displacement of at least 85%, has a lower production and/or shipping cost (when compared with wet disposable paper towels and/or cloth paper towels) and can be used for single use type of applications.

In some examples, a cleaning towel made from a fabric material and/or the particular weight density, as described herein, may be produced for delivery to wholesale buyers. Accordingly, a shape and/or a size of the cleaning towel may be customized according to a particular wholesale buyer's requirement. The cleaning towel may be produced as a continuous roll (or a continuous sheet) of a certain number of cleaning towels (e.g., 250, 500, or 1000) of a particular shape (e.g., a square or a rectangle) and/or a particular size (e.g., 16″×16″, 12″×12″, 10″×10″, 8″×8″, 6″×6″, 16″×12″, 16″×19″, 3.5″×2″, and so on). Additionally, or alternatively, the continuous roll of the certain number of cleaning towels may be perforated for easy cutting of each piece of a cleaning towel. For simplicity, a continuous roll of a certain number of cleaning towels may be referenced as a bulk roll.

In some examples, the bulk roll may be packaged in a carton, or a packaging made of a paper, a cardboard, a corrugated material, and/or a plastic. Alternatively, the bulk roll may be shrink-wrapped. A particular shape and/or a size of the carton, or the packaging may be determined based on a shape and/or a size of the bulk roll, which further depends on the shape and/or the size of a cleaning towel piece, and/or a total number of cleaning towels in the bulk roll.

In some examples, the carton, or the packaging of the bulk roll, may have a compartment for placing the bulk roll and a separate compartment for storing a liquid cleaning solution. The compartment in which the bulk roll is placed may have an opening to pull and separate a single piece of cleaning towel from the bulk roll. The opening may be a circular shape on a top panel of the carton or the packaging, and/or a slit on a side panel of the carton or the packaging. In some examples, the slit may be designed to use as a cutting mechanism when the bulk roll of the cleaning towel is not perforated according to a size of a single cleaning towel.

In some examples, cleaning towels may be cut according to a particular shape and/or a particular size from the bulk roll, folded, stacked, and packaged in a rectangular or square dispenser.

In some examples, a fabric of a cleaning towel may be made according to a spun-bonding process instead of a melt blown process. The fabric of the cleaning towel made using the spun-bonding process may have a particular three-dimensional periodic pattern on one surface side of the cleaning towel. The particular three-dimensional periodic pattern may help the cleaning towel to hold more amount of a liquid cleaning solution when the cleaning towel is merged in a container of the liquid cleaning solution and displace a higher amount of the liquid cleaning solution when the cleaning towel is placed on a surface being cleaned with a surface side with the particular three-dimensional periodic pattern face down.

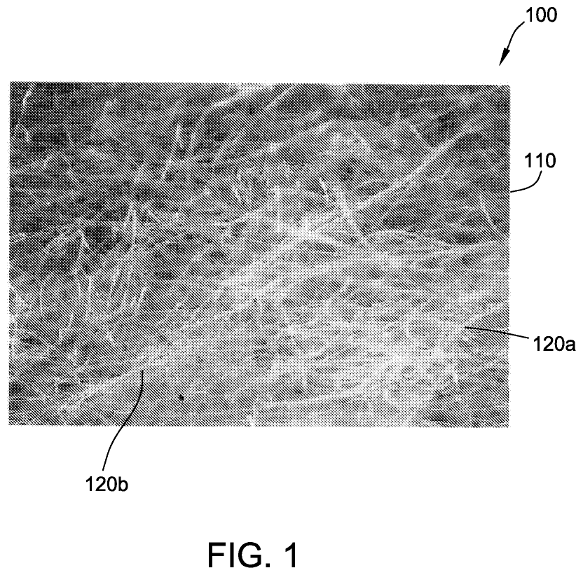

These and other features will be described in more detail with respect to FIG. 1A-FIG. 6.

FIG. 1 is a microscopic view 100 of a cleaning towel 110 according to an example. In an example, the cleaning towel 110 may be made from a fabric using a melt blown process. Thus, a fabric for the cleaning towel 110 may be made using a polypropylene (PP) type of material, polyethylene (PE) type of material, Bio-PE type of material, Bio-PP type of material, and/or other similar material, which is referenced herein as a fabric material. The fabric material used for making the cleaning towel may be a plastic material. Additionally, or alternatively, the fabric material may be a biodegradable plastic material.

In some examples, the material (e.g., the plastic or biodegradable plastic) may be processed through a melt blown process to produce a nonwoven fabric. During the melt blown process, polymers of the fabric material are converted into continuous filaments, which are shown in FIGS. 1 as 120a and 120b. The continuous filaments, including filaments 120a and 120b, are then used to make a nonwoven fabric. In an example, the continuous filaments are randomly laid. Since the cleaning towel 110 is made of a nonwoven fabric of plastic material, the cleaning towel may absorb a liquid cleaning solution when the cleaning towel is submerged in a bucket of a liquid cleaning solution and also release most, all, or substantially all of the liquid cleaning solution (which is generally known as quat), unlike cleaning towels made from cloth.

When the wet cleaning towel made from the nonwoven fabric of plastic material is placed on another surface for cleaning, the liquid cleaning solution may be transferred to the surface being cleaned. Since the cleaning towel releases the liquid cleaning solution better than standard cloth cleaning towels, an amount of liquid cleaning solution transferred from the cleaning towel to the other surface (which may be referenced herein as a displacement) is higher when compared to cloth cleaning towels. In some examples, the displacement is be between 90% to 100%. For example, the material of the cleaning towel absorbs the cleaning solution, but also releases it. In contrast, cleaning towels made from Rayon, paper, cotton, or linen do not release as much cleaning solution as was absorbed.

In some examples, the fabric of a cleaning towel may be made according to a spun-bonding process instead of a melt blown process. The fabric of the cleaning towel made using the spun-bonding process may have a particular three-dimensional periodic pattern on one surface side of the cleaning towel. The particular three-dimensional periodic pattern may help the cleaning towel hold more of the liquid cleaning solution when the cleaning towel is submerged in the container of the liquid cleaning solution. Additionally, the three-dimensional periodic pattern may displace a higher amount of the liquid cleaning solution when the cleaning towel is placed on a surface being cleaned.

In addition to the type of material being used, the cleaning towel 110 may be further improved by making the cleaning towel light in weight. A cleaning towel that is light in weight may reduce a unit cost of the cleaning towel as less fabric material may be required. Further, the cleaning towel that is light in weight may also reduce freight and/or shipping charges per each unit of a cleaning towel.

In some examples, the cleaning towel 110 that is light in weight may be made using a fabric material of a certain weigh density measured as grams per square meter (GSM). While currently available cleaning towels are made of a fabric having a weight density not less than 61 GSM, the cleaning towel 110 described herein may have a weight density less than 60 GSM, and in some cases, a weight density of as low as 10 GSM. In an example, the cleaning towel 110 has a weight density of between 20 GSM to 50 GSM. In such an example, the cleaning towel may be light in weight, strong enough to use for cleaning, and have a displacement of at least 85%.

In some examples, a cleaning towel 110 may have various shapes and/or sizes. For example, the cleaning towel 110 may be produced as a continuous roll of a certain number of cleaning towels. Further, each cleaning towel may have a particular shape and/or size. Additionally, or alternatively, the continuous roll of cleaning towels may be perforated for easy cutting of each piece of a cleaning towel.

In some examples, the roll of cleaning towels may be coreless. In another example, the cleaning towels may be folded, rolled or have other configurations. Alternatively, the roll of cleaning towels may have a particular color. The color may indicate a particular area where the cleaning towel 110 may be used for cleaning. For example, a roll of red cleaning towels may be used for cleaning a kitchen area, a green roll of cleaning towels may be used for cleaning a dining area and blue roll of cleaning towels may be used for cleaning washrooms, and so on. Although specific colors are mentioned, the cleaning towels may have any number of different colors.

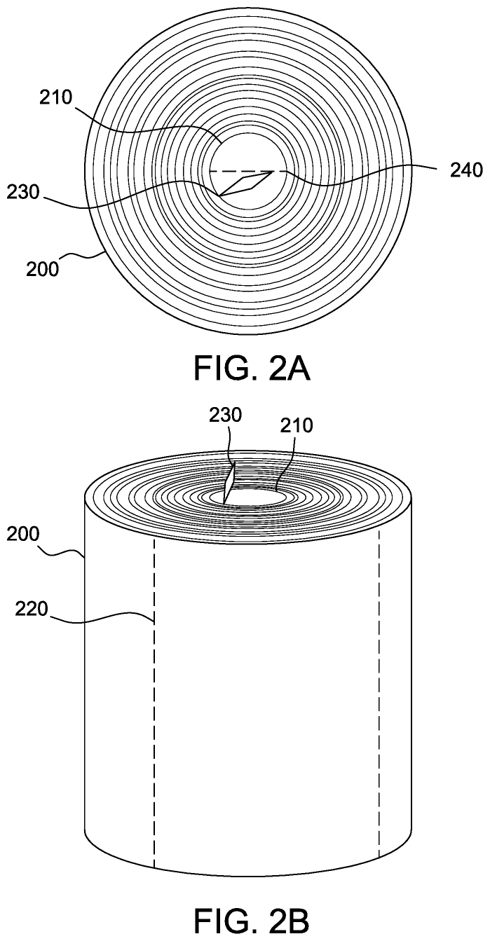

FIG. 2A is a top view of a roll of cleaning towels 200 according to an example. In an example, the roll of cleaning towels 200 are dry towels made according to the various examples described herein. Accordingly, the roll of cleaning towels 200 may be made from different materials and/or have different qualities, grades, gauges, shapes, sizes, and/or color, and so on.

In the example shown in FIG. 2A, the roll of cleaning towels 200 is coreless and configured to dispense cleaning towels from the center 210 of the roll of cleaning towels 200. For example, and as shown in FIG. 2A, an edge or side of one cleaning towel 230 may extend from the center 210 of the roll of cleaning towels 200. As such, an individual may grab the edge of the cleaning towel 230 and pull outward/upward to remove the cleaning towel 230 from the center of the roll of cleaning towels 200. Although a coreless roll is shown and described, the roll of cleaning towels 200 may include a center roll or core.

In an example, the roll of cleaning towels 200 is a continuous roll. As such, an individual may tear a length of cleaning towel 230 from the roll of cleaning towels 200. In another example and as shown in FIG. 2B, the roll of cleaning towels 200 includes a plurality of perforations 220 that enable the cleaning towel 230 in the roll of cleaning towels 200 to be separated from an adjacent cleaning towel.

During a manufacturing process, the roll of cleaning towels 200 is rolled such that the roll of cleaning towels 200 is round or substantially round. As indicated above, rolling the roll of cleaning towels 200 in this manner reduces manufacturing time and cost when compared with other methods of preparing cleaning towels to be provided in a dispenser (e.g., folding and/or cutting). As also indicated above, after the manufacturing process, the roll of cleaning towels 200 may subsequently be compressed which enables the roll of cleaning towels 200 to be provided in a non-circular dispenser.

To accomplish the above, the roll of cleaning towels 200 is rolled at a specific tension and with a particular center size. This allows the cleaning towels to be compressed to fit within a non-circular dispenser. In an example, the roll of cleaning towels 200 is rolled with a tension between approximately four pounds to approximately six pounds. If the tension is too tight, the roll of cleaning towels will not be able to be compressed and subsequently placed in the non-circular dispenser. However, if roll of cleaning towels is too loose, a desired number of cleaning towels may not be included in the roll of cleaning towels. In addition to the tension of the roll of cleaning towels 200, the size (e.g., diameter 240) of the center 210 is between approximately one and half inches to approximately four inches.

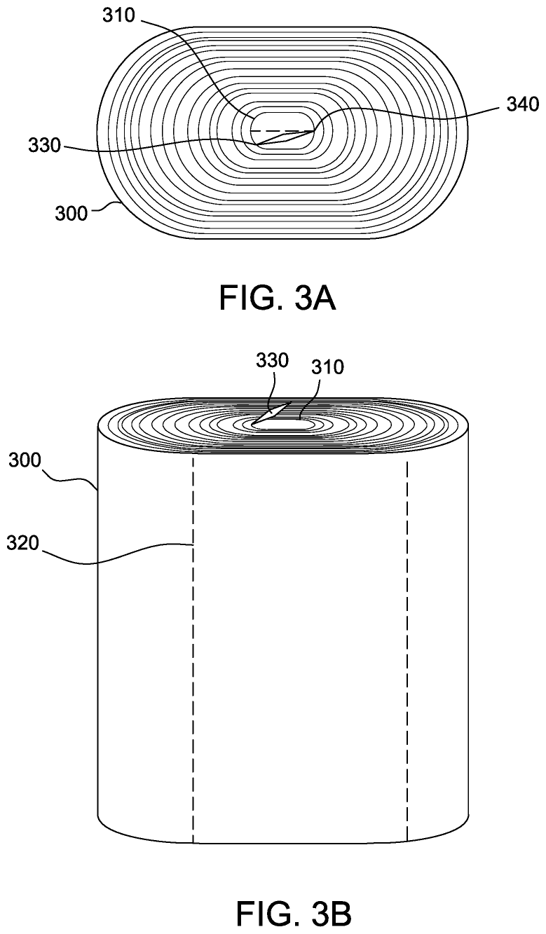

FIG. 3A is a top view of a roll of cleaning towels 300. In an example, the roll of cleaning towels 300 may be compressible. FIG. 3B is a perspective view of the roll of cleaning towels 300 according to an example.

The roll of cleaning towels 300 may be similar to the roll of cleaning towels 200 shown and described with respect to FIG. 2A-FIG. 2B. For example, the roll of cleaning towels 300 may have perforations 320 that enable adjacent cleaning towels to be separated from each other. Likewise, a single cleaning towel 330 may be dispensed from the center 310. As discussed above, the tension at which the roll of cleaning towels 300 was originally rolled, along with the size (e.g., diameter 340) of the center 310 enables the cleaning towel 330 to be center dispensed—even after the roll of cleaning towels 300 has been compressed.

In an example, the roll of cleaning towels 300 may be compressed by hand and subsequently placed in a dispenser. In another example, the roll of cleaning towels 300 may be compressed by a machine and subsequently placed in a dispenser.

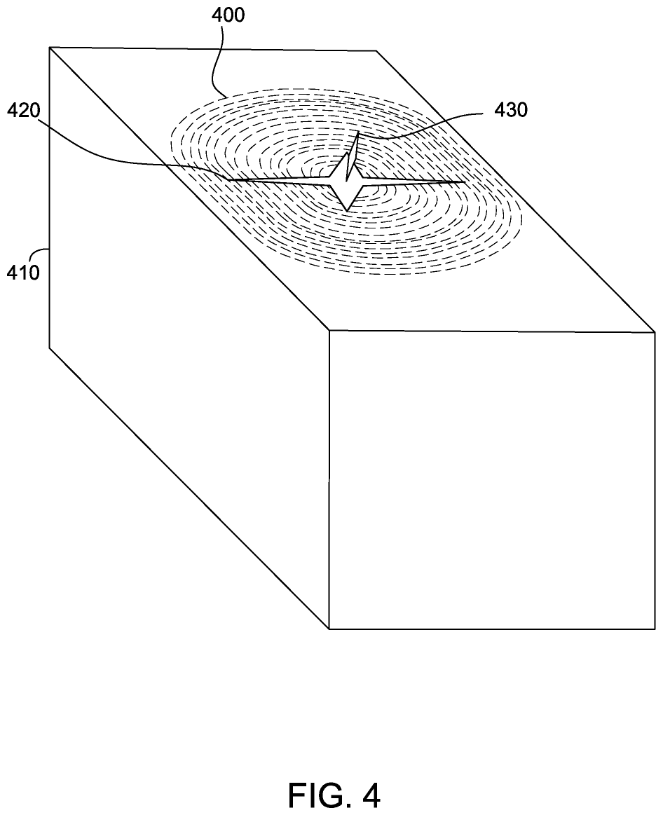

FIG. 4 illustrates a roll of cleaning towels 400 being disposed in a rectangular dispenser 410 according to an example. In an example, the roll of cleaning towels 400 may be similar to the roll of cleaning towels 300 shown and described with respect to FIG. 3A-FIG. 3B.

In the example of FIG. 4, the roll of cleaning towels 400 has been compressed and placed in a rectangular (or a non-circular) dispenser 410. By way of a non-limiting example, the roll of cleaning towels 400 may be compressed and placed in a square dispenser. In yet another example, the roll of cleaning towels 400 is placed in a circular dispenser. In such an arrangement, the roll of paper towels may not be compressed.

The dispenser 410 may be made of cardboard, chip board, paper, a corrugated material, plastic, and/or other suitable material. The dispenser 410 may define an opening 420 through which one or more cleaning towels 430 from the roll of cleaning towels 400 may be dispensed. Although a single opening 420 is shown and described the dispenser 410 may have any number of openings though which cleaning towels 330 may be dispensed. Additionally, the opening 420 may be defined at any location on the dispenser 410. In some examples, the opening 420 may have any shape. Additionally, the opening 420 may have a lid or cap that enables the opening to be closed when cleaning towels 430 are not being dispensed from the dispenser 410.

In some examples, the roll of cleaning towels may be shrink-wrapped. A particular shape and/or a size of dispenser 410 may be determined based on a shape and/or a size of the roll of cleaning towels, which further depends on the shape and/or the size of a cleaning towel piece, and/or a total number of cleaning towels in the roll of cleaning towels 400.

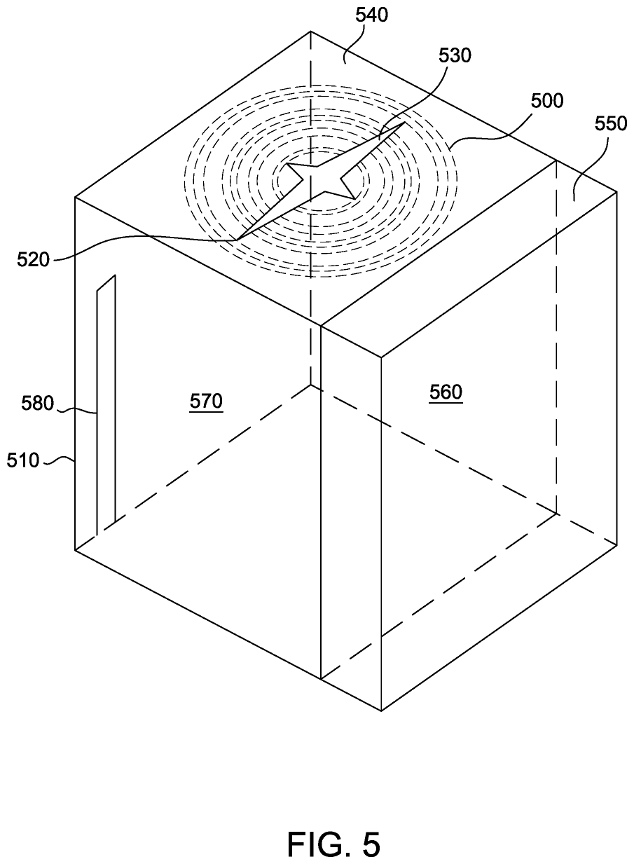

FIG. 5 illustrates a roll of cleaning towels 500 being disposed in a dispenser 510 according to an example. The dispenser 510 may be made of cardboard, chip board, paper, a corrugated material, plastic, and/or other suitable material. As shown in FIG. 5, the dispenser 510 may have a compartment 540 for placing the roll of cleaning towels 500 and a compartment 550 for storing of a liquid cleaning solution (e.g., quat) while cleaning the various types of surfaces.

The compartment 540 may define an opening 520 on a top panel 560 of the dispenser 510 (in particular, the compartment 540) through which one or more cleaning towels 530 from the roll of cleaning towels 500 may be dispensed. Although a single opening 520 is shown and described the compartment 510 may have any number of openings through which cleaning towels 530 may be dispensed. Additionally, the opening 520 may be defined at any location on the dispenser 510. In some examples, the opening 520 may have any shape. By way of a non-limiting example, the opening 520 may be in form of a slit 580 on a side panel 570 of the dispenser 510, and in particular the compartment 540. Additionally, the slit 580 on the side panel 570 may also define a cutting means, for example, when the roll of the cleaning towels does not include cleaning towels perforated according to a size of a single cleaning towel.

In some examples, cleaning towels may be cut according to a particular shape and/or a particular size from the bulk roll, folded, stacked, and packaged in a rectangular or square dispenser.

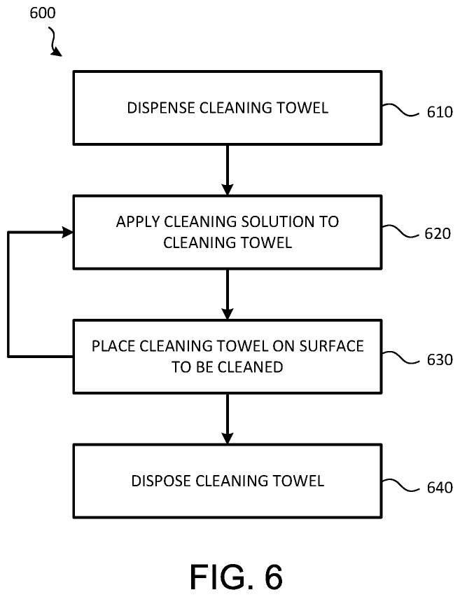

FIG. 6 illustrates a method 600 for using a cleaning towel according to an example. The cleaning towel part of a roll of cleaning towels such as described above with respect to FIG. 1-FIG. 5. In an example, the cleaning towel may be provided in a dispenser.

In an example, the method 600 begins when a cleaning towel has been dispensed (610) or otherwise made available for use. For example, when the cleaning towels are provided in a dispenser, one or more cleaning towels may be removed from the dispenser.

When the cleaning towel has been dispensed, a cleaning solution is applied (620) to the cleaning towel. The cleaning solution may be applied to the cleaning towel in a number of different ways. For example, the cleaning towel may be placed in a bucket of cleaning solution. In another example, the dispenser from which the cleaning towel is dispensed by include a cleaning solution. In yet another example, the cleaning solution may be sprayed or otherwise placed on a surface to be cleaned. The cleaning towel may then be used to wipe and/or absorb the cleaning solution.

Once the cleaning solution has been applied to the cleaning towel, the cleaning towel may be placed (630) on a surface to be cleaned. In an example, the cleaning towel releases 85% or more of the cleaning solution on the surface to be cleaned. Because the cleaning towel releases such a high amount of cleaning solution (when compared with current solutions) the cleaning towel described herein is better suited to disinfect and/or clean the surface.

This process may be used any number of times. For example, due to the materials from which the cleaning towel is made, the cleaning towel may be used any number of times. However, in some aspects, the cleaning towel may also be disposable. As such, after a certain number (or a predetermined number) of uses, the cleaning towel may be disposed (640).

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

The claimed disclosure should not be construed as being limited to any aspect, example, or detail provided in this disclosure. Regardless of whether shown and described in combination or separately, the various features (both structural and methodological) are intended to be selectively rearranged, included or omitted to produce examples with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

References to an element herein using a designation such as “first,” “second,” and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

What is claimed is:

1. A cleaning towel, comprising:
a fabric prepared by a melt blown process using a particular type of material, the fabric designed to:
have a weight density in a particular range such that the cleaning towel is light in weight; and
transfer at least a particular percentage of a liquid cleaning solution to a surface on which the cleaning towel is placed.

2. The cleaning towel of claim 1, wherein the particular type of material used for making the fabric includes one or more of: a polypropylene (PP) type of material, a polyethylene (PE) type of material, a Bio-PE type of material, or a Bio-PP type of material.

3. The cleaning towel of claim 1, wherein the particular range of the weight density of the fabric is between ten grams per square meter (GSM) to sixty GSM.

4. The cleaning towel of claim 1, wherein the particular range of the weight density of the fabric is twenty grams per square meter (GSM) to fifty GSM.

5. The cleaning towel of claim 1, wherein the fabric may include one or more colors.

6. The cleaning towel of claim 1, wherein the particular percentage is at least eighty-five percent.

7. The cleaning towel of claim 1, wherein the particular percentage is at least ninety percent.

8. A product, comprising:
a continuous sheet of a fabric prepared by a melt blown process, wherein the fabric is designed to:
have a weight density that is below predetermined threshold value; and
have a liquid displacement characteristic that meets a particular criterion; and
the continuous sheet is designed to be separable by a plurality of perforations.

9. The product of claim 8, wherein the continuous sheet of the fabric is rolled.

10. The product of claim 9, wherein the rolled fabric is coreless.

11. The product of claim 10, wherein the rolled product is compressed.

12. The product of claim 8, wherein the product is a dry fabric product.

13. The product of claim 8, wherein the particular type of material used for making the continuous sheet of the fabric includes one or more of: a polypropylene (PP) type of material, a polyethylene (PE) type of material, a Bio-PE type of material, or a Bio-PP type of material.

14. The product of claim 8, wherein the continuous sheet of the fabric is provided in a dispenser.

15. The product of claim 14, wherein a cleaning solution is placed in the dispenser.

16. The product of claim 15, wherein the dispenser includes a first compartment to place the fabric and a second compartment to hold the cleaning solution.

17. A method, comprising:
placing a melt blown cleaning towel in a cleaning solution;
based on the cleaning towel absorbing the cleaning solution, placing the melt blown cleaning towel on a surface; and
cleaning the surface with at least an eighty-five percent quat efficacy.

18. The method of claim 17, further comprising re-using the melt blown cleaning towel.

19. The method of claim 18, wherein a subsequent surface is also cleaned with the at least the eighty-five percent quat efficacy.

20. The method of claim 19, further comprising disposing the melt blown cleaning towel after a predetermined number of uses.
